(19) United States
(12) Patent Application Publication
(10) Pub. No.: US 2011/0246608 A1
(43) Pub. Date: Oct. 6, 2011

(54) SYSTEM, METHOD AND DEVICE FOR DELIVERING STREAMING MEDIA

(75) Inventors: Yichuan Wu, Beijing (CN); Hongluan Liao, Beijing (CN); Naibao Zhou, Beijing (CN); Jin Peng, Beijing (CN); Yunfei Zhang, Beijing (CN); Xiaodong Duan, Beijing (CN); Bing Wei, Beijing (CN)

(73) Assignee: China Mobile Communications Corporation, Beijing (CN)

(21) Appl. No.: 13/126,433

(22) PCT Filed: Sep. 28, 2009
(86) PCT No.: PCT/CN09/01102

§ 371 Date: Jun. 21, 2011

(30) Foreign Application Priority Data
Oct. 27, 2008 (CN) 200810225211.X

(51) Int. Cl. G06F 15/16

(52) U.S. Cl. 709/217

(57) ABSTRACT

A system, a method and an apparatus for distributing streaming media, include that a terminal node sends the inquiry request carrying the address information of itself to a global server; the global server determines the affiliated domain of the terminal node according to the address information, and returns the domain server information of the affiliated domain; the terminal node sends streaming media data obtaining request to the domain server of the affiliated domain; the domain server of the affiliated domain inquires whether there is the streaming media data in its local domain; if yes, the streaming media data is returned and/or the information of the other terminal nodes which have the streaming media data in their local domains is returned; if not, the requested streaming media data is obtained from the other domain servers in the core network and/or the global server and sent to the terminal node by the way of P2P; the terminal node receives the returned streaming media data and/or obtains the requested streaming media data from the other terminal nodes by the way of P2P according to the returned information of the other terminal nodes. The system can satisfy the demand of streaming media distributing of the large-scale concurrent users.

### FIELD OF THE INVENTION

The present invention relates to the field of networks and particularly to a streaming media delivery system, method and device for mass delivery of streaming media.

### BACKGROUND OF THE INVENTION

Streaming media refers to a continuous data stream of audio/video transmitted and played over a data network in a temporal sequence. People ever had to firstly download and store a complete audiovisual file on a local computer and then watch or listen to it when they intended to watch a movie or listen to music. Unlike the traditional playing method, it is not necessary to download a complete file of streaming media but just a part of contents thereof are buffered prior to playing so that data stream of the streaming media is played while being transported to save both a wait period of time and a storage space for downloading.

However, how to serve a large number of concurrent users by delivering contents of streaming media has been an issue of sustaining attention in the field of distributed computer networks and multimedia researches. Streaming media delivery approaches available at present include the following ones.

(1) Client/Server (C/S)

FIG. 1 illustrates a schematic structural diagram of a C/S scheme, where a separate data channel is required to be established between each client and a server, each user has to transmit a separate data query request to the media server, and the media server has to transmit a copy of the requested data packet to each user. Delivery of the data is performed by the dedicated server, and the multiple clients acquire the data from the same server.

In this scheme, it is easy to both control consistency of the data and manage the system. However, a bottleneck may occur with the streaming media server or the network bandwidth in the C/S scheme because the system with only one server tends to occur a single failure point, and the single server for a large number of clients can not accommodate a demand of an increasing number of users and may suffer from poor extensibility due to a limited Central Processing Unit (CPU) capability, memory size, network bandwidth, etc. Although the performance of the streaming media service system can be improved by clustering servers and increasing the bandwidth of the network outlet, which boosts the capacity of the streaming media service system, the active demand of a large number of users for delivery of streaming media can not be accommodated. Moreover, this solution has to be performed at the cost of expensive hardware to thereby result in costly delivery of streaming media.

(2) Internet Protocol (IP) multicast.

FIG. 2 illustrates a schematic structural diagram of an IP multicast scheme in which a network with multicast ability is built to allow a router to duplicate a data packet onto multiple channels at a time. With multicasting, a single server can transmit a continuous data stream concurrently to hundreds of thousands of clients without any delay. The server transmits just an information packet instead of multiple ones, and all of clients sending requests share the same information packet. For example, users A, B, C, D and E in FIG. 2 share the same data packet transmitted from the server. The information packet can be transmitted to a client at any address to reduce a total number of information packets transmitted over the network, thereby alleviating the load on the server and over the network, greatly improving the efficiency of utilizing the network and lowering the cost. However, IP multicast is difficult to be deployed practically over the Internet due to its inherent drawbacks of aspects including reliable transmission, congestion control and security, which are difficult to address.

(3) Content Delivery Network (CDN)

FIG. 3 illustrates a schematic structural diagram of a Content Delivery Network (CDN).

A proxy buffer or a Content Delivery Network (CDN) server is deployed at the edge of a network, and a media server “pushes” or “pulls” media contents for storage on the CDN server or the proxy buffer. As illustrated in FIG. 3, for example, the server firstly pushes the media contents to content delivery nodes A, B, C and D. A client requesting the media server may be served from the proxy buffer or the CDN server without consuming any resource of the media server. As illustrated in FIG. 3, for example, a user retrieves desired media contents from the content delivery node B. However, the CDN server also offers the service in the C/S scheme, so the problem of extensibility still exists.

(4) Peer-to-Peer (P2P) delivery of streaming media

FIG. 4 illustrates a schematic structural diagram of a P2P-based streaming media delivery system over a P2P network consists of nodes. P2P-based network streaming media has a feature of being played more smoothly and stably for more users. P2P streaming media enables a user watching video streaming media over the network to utilize resources of other users watching the video at the same time so that the user can also download the video from these users.

The P2P delivery system generally has two features. Firstly, the users interact directly because the P2P delivery system is connected to computers of other users for exchange of a file, as opposed to that the users ever had to be connected to the server for browsing and downloading. The P2P delivery system indeed eliminates an intermediate node (e.g., the server) to facilitate easier and more direct sharing and interaction over the network. Secondly, the condition in which a large website acts as the center over the network is altered to bring “out of centralization” back and let the users take the initiative.

Due to features of streaming media, e.g., required real-time transmission, considerable consumption of a bandwidth resource, long duration of transmission, etc., the use of the traditional C/S serving scheme may result in problems of a significant Input/Output (I/O) load pressure, poor extensibility, costly deployment of the system, etc. Furthermore, under the condition of a large number of concurrent service requests, it is difficult to guarantee a Quality of Service (QoS) available from the streaming media system in the C/S serving scheme, thus resulting in a poor Quality of Experience (QoE) of the user during playing the streaming media.

The use of IP multicast for delivery of media data suffers from problems of reliable transmission, congestion control, security, etc., and mass deployment thereof over the Internet has still been difficult although it was proposed years ago.

The Content Delivery Network (CDN) which has been widely deployed over the Internet in recent years pushes contents to a node at the “edge” of the network closer to the user to thereby alleviate a load pressure on the central content server and over the backbone network and improve a user's experience of using the streaming media. However, the devoted cost of deploying a CDN system may be increased linearly with the number of concurrent users supportable by the system because the C/S serving scheme is still adopted for a delivery node at the “edge” of the CDN. An operator has to invest significantly in hardware devices of the servers and the bandwidth of the network in order to serve massive streaming media, thus resulting in a high cost of deployment.

Intensive investigation and development of a pure P2P-based streaming media delivery architecture has been ongoing in recent years due to its low cost of deployment and good system extensibility, and for example, P2P streaming media services of PPLive, TVCoo, UUSee, PPStreaming, etc., for Internet Protocol TV have emerged recently in China. However, a uni-domain deployment scheme is generally adopted in the pure P2P streaming media architecture, and its streaming media services still suffer from the problems of difficulty with guaranteeing the reliability and the QoS of the system.

### SUMMARY OF THE INVENTION

Embodiments of the invention provide a system, method and device for delivering streaming media, which can accommodate a demand of a large number of concurrent users for delivery of streaming media with high reliability and strong extensibility.

A system for delivering streaming media according to an embodiment of the invention includes a global server, domain servers and ordinary nodes, wherein the global server and the domain servers constitute a Peer-to-Peer, P2P, core network, and each of the domain servers and the ordinary nodes hosted in the domain constitute a P2P access network; the global server is configured to receive a query request carrying address information transmitted from an ordinary node, query a correspondence relationship between address information and hosting domains according to the address information in the query request to determine a hosting domain of the ordinary node, and return information on a domain server of the hosting domain; the domain server is configured to receive a streaming media data retrieval request transmitted from the ordinary node in the hosting domain and return information on other ordinary nodes in the hosting domain currently possessing requested streaming media data and/or return the locally stored requested streaming media data; and the ordinary node is configured transmit the query request carrying the address information to the global server, transmit the streaming media data retrieval request to the domain server of the hosting domain according to the information on the domain server returned from the global server, and receive the streaming media data returned from the domain server of the hosting domain or retrieve the streaming media data from the other ordinary nodes according to the information on other ordinary nodes returned from the domain server of the hosting domain.

A method for delivering streaming media according to an embodiment of the invention includes: transmitting, by an ordinary node, a query request carrying its own address information to a global server; querying, by the global server, a correspondence relationship between address information and hosting domains according to the address information in the query request, determining a hosting domain of the ordinary node and returning information on a domain server of the hosting domain, wherein the global server and domain servers constitute a Peer-to-Peer, P2P, core network, and the domain server and ordinary nodes hosted in the domain constitute a P2P access network; transmitting, by the ordinary node, a streaming media data retrieval request to the domain server of the hosting domain; inquiring, by the domain server of the hosting domain, about whether the requested streaming media data is present in the hosting domain; and if so, returning the locally stored streaming media data and/or information on other ordinary nodes in the hosting domain possessing the requested streaming media data; otherwise, retrieving the requested streaming media data from other domain servers and/or the global server in the core network through P2P and transmitting the retrieved streaming media data to the ordinary node transmitting the retrieval request; and receiving, by the ordinary node, the returned streaming media data and/or retrieving the requested streaming media data from the other ordinary nodes through P2P according to the returned information on the other ordinary nodes.

A global server according to an embodiment of the invention includes a portal module, an index module and a resource management module, wherein: the portal module is configured to receive a query request carrying address information transmitted from an ordinary node, query a correspondence relationship between address information and hosting domains according to the address information in the query request to determine a hosting domain of the ordinary node, and return information on a domain server of the hosting domain; the index module is configured to receive streaming media data request information transmitted from the domain server and return information on domain servers in a core network possessing the streaming media data; and the resource management nodule is configured to receive a streaming media data retrieval request transmitted from the domain server and return the locally stored requested streaming media data.

A domain server according to an embodiment of the invention includes a data management module and an information index module, wherein: the data management module is configured to receive a streaming media data retrieval request transmitted from an ordinary node in a hosting domain, and return locally stored requested streaming media data or retrieve the streaming media data from other domain servers or a global server in a core network and return the retrieved streaming media data to the ordinary node transmitting the retrieval request; and the information index module is configured to receive the streaming media data retrieval request transmitted from the ordinary node in the hosting domain and return information on other ordinary nodes in the same domain currently possessing the streaming media data.

In the embodiments of the invention, the global server and the domain servers in the network constitute a Peer-to-Peer (P2P) core network, and each of the domain servers and the ordinary nodes hosted in the domain constitute a P2P access network; an ordinary node transmits a query request to the global server to acquire information on the domain server of the hosting domain and then transmits a streaming media data retrieval request to the domain server of the hosting domain to retrieve streaming media data; the hybrid P2P architecture is adopted in combination with the traditional CDN and P2P to benefit from the advantages of reliability and extensibility; and resources of the ordinary nodes are made full use of to constitute a highly extensible system for delivering streaming media to perform QoS-guaranteed mass delivery of streaming media (including P2P live video and video on demand services) at a lower cost of deployment.

### BRIEF DESCRIPTION OF THE DRAWINGS

FIG. 1 illustrates a schematic structural diagram of a C/S scheme in the prior art;

FIG. 2 illustrates a schematic structural diagram of an IP multicast scheme in the prior art;

FIG. 3 illustrates a schematic structural diagram of a Content Delivery Network (CDN) in the prior art;

FIG. 4 illustrates a schematic structural diagram of a P2P-based streaming media delivery system in the prior art;

FIG. 5 illustrates a schematic structural diagram of a system for delivering streaming media according to an embodiment of the invention;

FIG. 6 illustrates a flow chart of a method for delivering streaming media according to an embodiment of the invention;

FIG. 7 illustrates a flow chart of delivering streaming media through an intermediate ordinary node according to an embodiment of the invention;

FIG. 8 illustrates a schematic structural diagram of a global server according to an embodiment of the invention;

FIG. 9 illustrates a schematic structural diagram of a domain server according to an embodiment of the invention;

FIG. 10 illustrates a schematic diagram of a specific structure of a system for delivering streaming media according to an embodiment of the invention;

FIG. 11 illustrates a schematic diagram of retrieving streaming media data by an ordinary node from the hosting domain according to a first embodiment of the invention;

FIG. 12 illustrates a schematic diagram of retrieving streaming media data by the ordinary node from outside of the hosting domain according to the first embodiment of the invention;

FIG. 13 illustrates a schematic diagram of retrieving streaming media data through an intermediate ordinary node according to a second embodiment of the invention; and

FIG. 14 illustrates a schematic diagram of sharing hot contents according to a third embodiment of the invention.

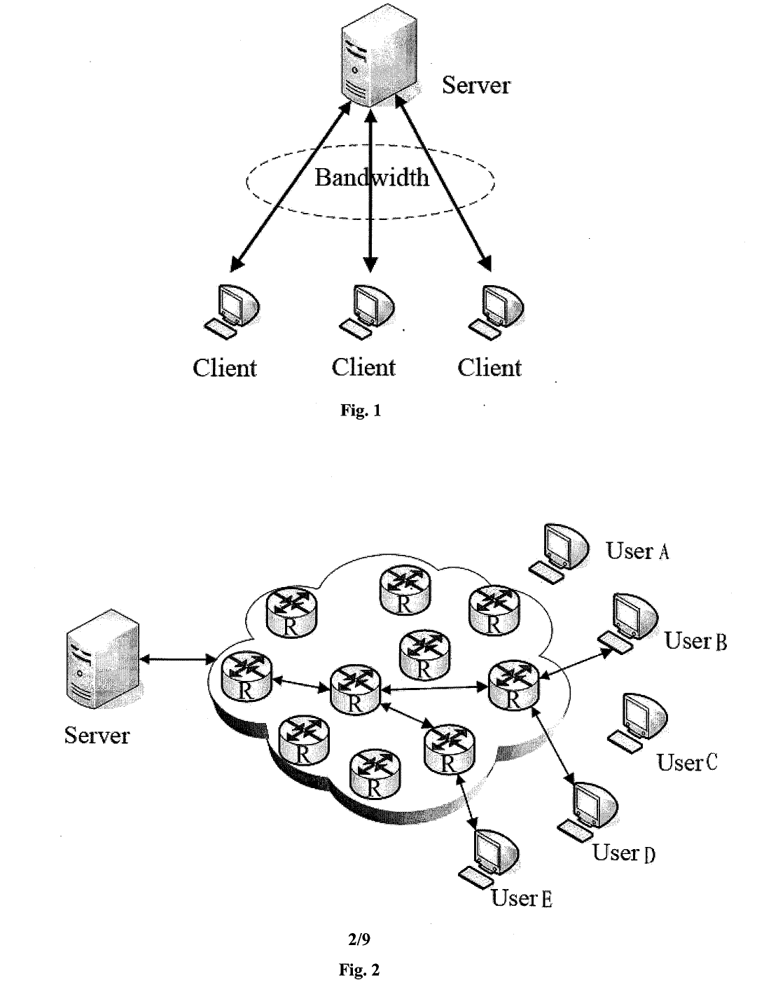

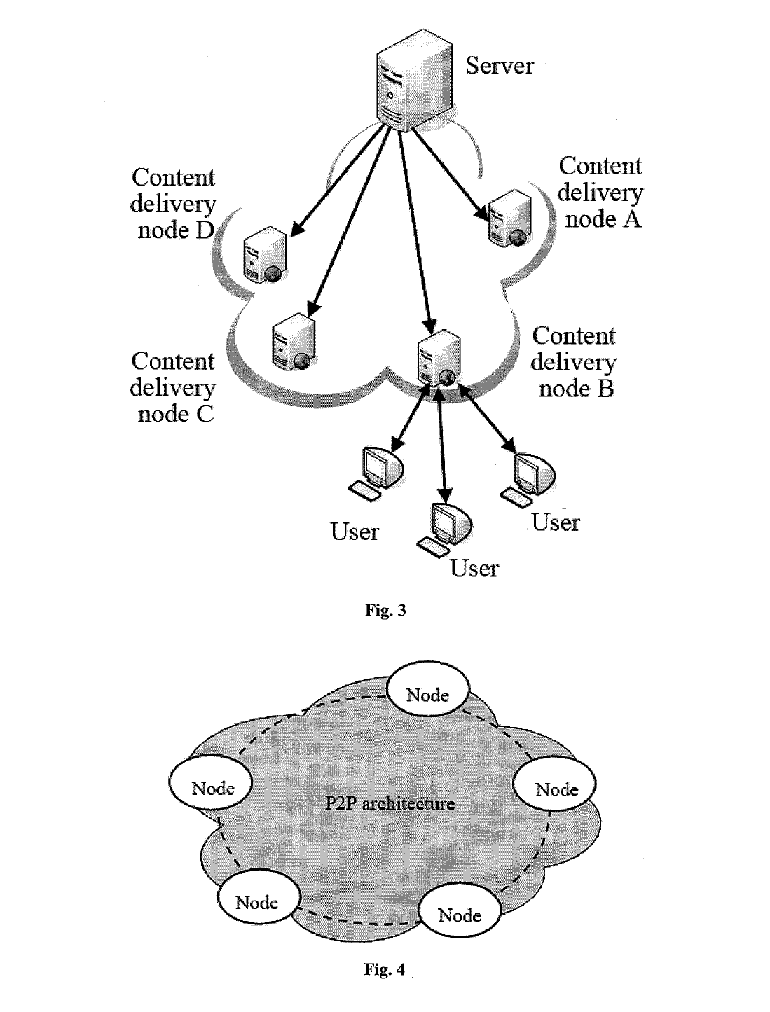

### DETAILED DESCRIPTION OF THE EMBODIMENTS

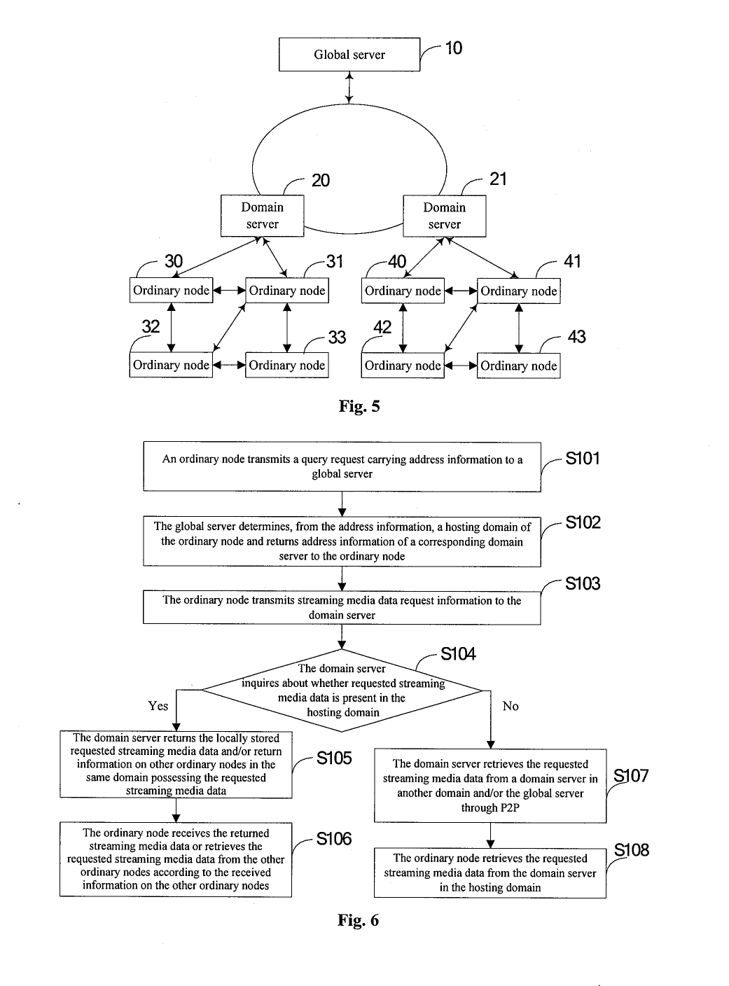

A system for mass delivery of streaming media according to an embodiment of the invention structured as illustrated in FIG. 5 includes a global server, domain servers and ordinary nodes, e.g., a global server 10, domain servers 20 and 21, and Ordinary Nodes (ONs) 30, 31, 32, 33, 40, 41, 42 and 43.

The system is of a two-level structure in which the domain servers are P2P-connected and also the ordinary nodes in a domain are P2P-connected. Particularly, an ordinary node is hosted in a domain according to its address information, one or more domain servers may be deployed in a domain, ordinary nodes and the domain server(s) in the same domain constitute a P2P access network, and the domain servers in all domains and the global server constitute a P2P core network.

For example, the ordinary nodes 30, 31, 32 and 33 are hosted in the same domain and constitute, together with the domain server 20 of the same domain, a P2P access network, and the ordinary nodes 40, 41, 42 and 43 are hosted in the same domain and constitute, together with the domain server 21 of the same domain, a P2P access network. The domain servers 20 and 21 and the global server 10 constitute a P2P core network. The ordinary nodes and the domain server(s) in the same domain are referred collectively to as domain nodes.

The global server 10 is a seeder server of streaming media contents in the core network from which all streaming media data of the domain servers in the core network originates, and the domain server 20 or 21 is a seeder node of streaming media contents in a domain from which all streaming media data of the ordinary nodes in the domain originates.

General functions of the global server, the domain server and the ordinary node are introduced below.

The global server may be configured to store a correspondence relationship between address information and hosting domains of ordinary nodes, streaming media data and information on streaming media data possessed currently by the domain servers.

The global server is configured to receive a query request carrying address information transmitted from an ordinary node, query the correspondence relationship with the address information to determine a hosting domain of the ordinary node, and return information on a domain server in the hosting domain.

The global server is further configured to receive a streaming media data retrieval request transmitted from a domain server and return information on domain servers in the core network currently possessing streaming media data requested by the domain server and/or return the locally stored streaming media data requested by the domain server.

The global server is further configured to count requests for streaming media data over streaming media channels in the domain servers and broadcast information on those of the domain servers possessing the streaming media data with a count of requests exceeding a preset value over the core network.

The global server is further configured to update the locally stored information on the streaming media data possessed currently by the domain servers in response to a received streaming media information update request transmitted from the domain servers.

The domain server is configured to receive a streaming media data retrieval request transmitted from an ordinary node in the same domain, and return information on other ordinary nodes in the same domain currently possessing requested streaming media data and/or return the locally stored requested streaming media data, or retrieve the requested streaming media data from another domain server or the global server in the core network and return the requested streaming media data to the ordinary node transmitting the request.

The domain server may be configured to locally store the retrieved streaming media data and store information on streaming media data possessed currently by the ordinary nodes in the same domain.

The domain server is further configured to connect to all or a part of the domain servers possessing the streaming media data with a count of requests exceeding the preset value and retrieve the streaming media data when the streaming media data with a count of requests exceeding the preset value as broadcast from the global server is not locally stored.

The domain server is further configured to transmit a streaming media information update request to the global server upon retrieval of streaming media data or deletion of possessed streaming media data.

The domain server is further configured to update the information on the streaming media data possessed currently by the ordinary nodes in the same domain in response to a received streaming media information update request.

The domain server is further configured to select one of the ordinary nodes in the same domain as an intermediate ordinary node upon reception of a streaming media data retrieval request transmitted from a mobile terminal or select another ordinary node in the same domain as an intermediate ordinary node upon reception of a streaming media data retrieval request transmitted from an ordinary node in the same domain.

The ordinary node is configured to transmit the query request carrying the address information to the global server, transmit the streaming media data retrieval request to the domain server of the hosting domain according to the information on the domain server returned from the global server, and receive the streaming media data returned from the domain server of the hosting domain or retrieve the streaming media data from other ordinary nodes according to the information on other ordinary nodes returned from the domain server of the hosting domain.

The ordinary node is further configured to transmit the streaming media information update request to the domain server of the hosting domain upon retrieval of streaming media data or deletion of possessed streaming media data. Thereby, a resource can be shared between the ordinary nodes.

In particular, the ordinary node may also function, if necessary, as an Intermediate Ordinary Node (ION) to retrieve streaming media data requested by a mobile terminal or another ordinary node and to provide the streaming media data to the mobile terminal or the another ordinary node transmitting the streaming media data retrieval request.

An ordinary node with high computing capability may function as an intermediate ordinary node to be a proxy of a device, e.g., a mobile terminal, which is configured to request streaming media data from the global server, a domain server (also referred to as a Super Node (SN)) or other ordinary nodes and provide intermediate downloading of the streaming media data for an ordinary node transmitting a request, or to aid an ordinary node in another domain to implement Network Address Translation (NAT) or firewall traversal.

FIG. 6 illustrates a flow of mass delivery of streaming media with the foregoing system, which includes the following operations S101-S108.

In the operation S101, an ordinary node transmits a query request carrying address information to a global server.

In the operation S102, the global server determines, from the address information, a hosting domain of the ordinary node and returns address information of a corresponding domain server to the ordinary node.

In the operation S103, the ordinary node transmits streaming media data request information to the domain server of the hosting domain.

The domain server stores information on streaming media data possessed in the hosting domain (including the domain server and ordinary nodes), where the information on streaming media data indicates what streaming media data the domain server and the ordinary nodes possess.

In the operation S104, the domain server inquires about whether streaming media data requested by the ordinary node is present in the hosting domain, i.e., whether the domain server and the ordinary nodes in the hosting domain possess the requested streaming media data. If so, the flow goes to the operation S105; otherwise, the flow goes to the operation S107.

In the operation S105, the domain server returns the locally stored requested streaming media data and/or returns information on other ordinary nodes in the same domain possessing the requested streaming media data.

In the operation S106, the ordinary node receives the returned streaming media data, or retrieves the requested streaming media data from the other ordinary nodes in the same domain through P2P according to the received information on the other ordinary nodes.

The ordinary node retrieves the requested streaming media data from the other ordinary nodes in the same domain through P2P according to the received information on the other ordinary nodes particularly as follows: the ordinary node receives and parses the information on the other ordinary nodes returned from the domain server and knows the other ordinary nodes possessing the requested streaming media data; and the ordinary node initiates connections to a part or all of the other ordinary nodes and retrieves the requested streaming media data from those of the other ordinary nodes to which the connections have been established successfully.

In the operation S107, the domain server retrieves the requested streaming media data from a domain server in another domain and/or the global server through P2P, particularly as follows: the domain server forwards the received streaming media data request information from the ordinary node to the global server, where the global server stores a distribution condition of streaming media data in the global server and the domain servers of the respective domains, i.e., information on the streaming media data, which indicates what streaming media data the global server and the domain servers possess; the global server queries the global server/the other domain servers in the core network according to the request information, and returns the requested streaming media data and/or returns information on other domain servers currently possessing the requested streaming media data; the domain server stores the returned streaming media data, or receives and parses the information on other domain servers and knows the other domain servers possessing the requested streaming media data; and the domain server initiates connections to a part or all of the other domain servers possessing the requested streaming media data and retrieves the requested streaming media data from those of the other domain servers to which the connections have been established successfully.

The domain server notifies the ordinary node transmitting the streaming media data request information upon retrieval of the streaming media data.

In the operation S108, the ordinary node retrieves the requested streaming media data from the domain server in the hosting domain.

The ordinary node retrieves the requested streaming media data from the domain server in the hosting domain upon reception of the notification of the domain server.

A fixed user may have an access through a terminal device, e.g., PC, and participate in delivering contents of streaming media over the network in addition to downloading and playing of the streaming media.

In particular, an ordinary node with high computing capability may also function as an intermediate ordinary node configured to serve a terminal incapable of accessing directly the system for delivering streaming media by relaying streaming media data. For example, a mobile user may have an access through a terminal device, e.g., a mobile terminal, and download and play streaming media from an Intermediate Ordinary Node (ION) but not participate in delivering the contents of the streaming media over the network, and an ordinary node with a weak computing capability, which temporarily can not have an access or fails for long to be connected, may retrieve requested streaming media data through an intermediate ordinary node.

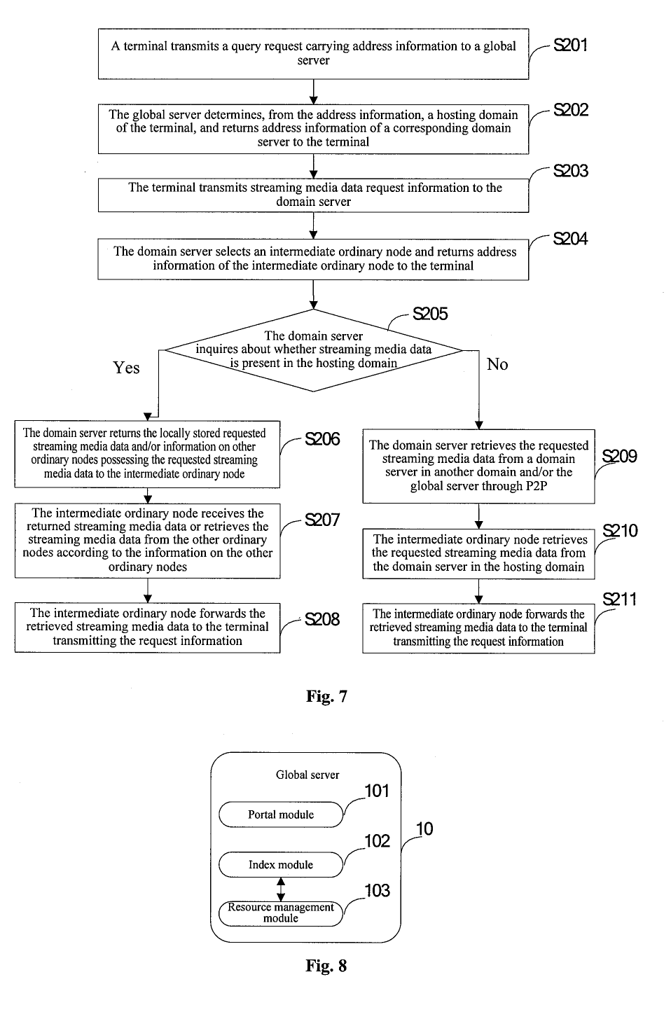

In the method for mass delivery of streaming media according to an embodiment of the invention, a terminal may further retrieve streaming media data through an intermediate ordinary node in a process as illustrated in FIG. 7, which includes the following operations S201-S211.

In the operation S201, a mobile terminal/an ordinary node transmits a query request carrying address information to a global server.

In the operation S202, the global server determines, from the address information, a hosting domain of the mobile terminal/the ordinary node, and returns address information of a corresponding domain server to the mobile terminal/the ordinary node.

In the operation S203, the mobile terminal/the ordinary node transmits streaming media data request information to the domain server of the hosting server.

In the operation S204, the domain server selects one of ordinary nodes in the hosting domain as an intermediate ordinary node and returns address information of the intermediate ordinary node to the mobile terminal/the ordinary node.

Generally, the domain server selects one of ordinary nodes in the hosting domain as an intermediate ordinary node upon determining that the mobile terminal/the ordinary node transmitting the streaming media data request information is incapable of a direct access.

In the operation S205, the domain server inquires about whether streaming media data requested by the mobile terminal/the ordinary node is present in the hosting domain, i.e., whether the domain server and the ordinary nodes in the hosting domain possess the requested streaming media data. If so, the process goes to the operation S206; otherwise, the process goes to the operation S209.

In the operation S206, the domain server returns the locally stored requested streaming media data and/or information on other ordinary nodes in the same domain possessing the requested streaming media data to the selected intermediate ordinary node.

In the operation S207, the intermediate ordinary node receives the returned streaming media data or retrieves the requested streaming media data from other ordinary nodes in the same domain through P2P according to the returned information on other ordinary nodes.

The intermediate ordinary node retrieves the requested streaming media data from other ordinary nodes in the same domain according to the received information on other ordinary nodes particularly as follows: the intermediate ordinary node receives and parses the information on other ordinary nodes returned from the domain server and knows the other ordinary nodes possessing the requested streaming media data; and the intermediate ordinary node initiates connections to a part or all of the other ordinary nodes and retrieves the requested streaming media data from those of the other ordinary nodes to which the connections have been established successfully.

In the operation S208, the mobile terminal/the ordinary node retrieves the requested streaming media data from the intermediate ordinary node, particularly as follows: the mobile terminal/the ordinary node establishes a connection to the intermediate ordinary node according to the address information of the intermediate ordinary node and retrieves the requested streaming media data.

In the operation S209, the domain server retrieves the requested streaming media data from a domain server in another domain and/or the global server through P2P, particularly as follows: the domain server forwards the received streaming media data request information transmitted from the mobile terminal/the ordinary node to the global server; the global server queries the global server/the other domain servers in the core network according to the request information, and returns the requested streaming media data and/or returns information on those of the other domain servers currently possessing the requested streaming media data; the domain server stores the returned streaming media data, or receives and parses the information on other domain servers and knows the other domain servers possessing the requested streaming media data; and the domain server initiates connections to a part or all of the other domain servers possessing the requested streaming media data and retrieves the requested streaming media data from those of the other domain servers to which the connections have been established successfully.

The domain server notifies the selected intermediate ordinary node upon retrieval of the streaming media data.

In the operation S210, the intermediate ordinary node retrieves the requested streaming media data from the domain server in the hosting domain.

The intermediate ordinary node retrieves the requested streaming media data from the domain server in the hosting domain upon reception of the notification of the domain server.

In the operation S211, the mobile terminal/the ordinary node retrieves the requested streaming media data from the intermediate ordinary node, particularly as follows: the mobile terminal/the ordinary node establishes a connection to the intermediate ordinary node according to the address information of the intermediate ordinary node and retrieves the requested streaming media data.

Furthermore, the ordinary node (including when it functions as an intermediate ordinary node) transmits a streaming media information update request to the domain server in the hosting domain upon retrieval of the streaming media data or deletion of possessed streaming media data, and the domain server updates locally stored information on streaming media data possessed currently by the ordinary nodes in the hosting domain in response to the received streaming media information update request.

Furthermore, the domain server transmits a streaming media information update request to the global server upon retrieval of streaming media data or deletion of possessed streaming media data, and the global server updates locally stored information on streaming media data possessed currently by the domain servers in the core network in response to the received streaming media information update request.

The method for mass delivery of streaming media according to an embodiment of the invention further includes: the global server periodically counts requests for streaming media data over respective streaming media channels in the core network.

When the requests for the streaming media data over a streaming media channel exceed a preset value, the streaming media data over the streaming media channel is determined as hot contents.

After discovering the hot contents, the global server broadcasts information on the domain servers possessing the hot contents, i.e., information on the domain servers possessing the streaming media data with a count of requests exceeding the preset value, over the core network.

The other domain servers determine whether the hot contents are possessed locally upon reception of the information on the hot contents as broadcast from the global server. If not so, they establish connections to a part or all of the domain servers possessing the hot contents according to the received information on the domain servers possessing the hot contents and retrieve and store the streaming media data corresponding to the hot contents from those of the domain servers to which the connections have been established successfully. The other domain servers transmit streaming media information update requests for updating the information on the domain servers of the streaming media data in the global server upon retrieval of the streaming media data corresponding to the hot contents.

In the system for mass delivery of streaming media as illustrated in FIG. 5, the global server 10 structured as illustrated in FIG. 8 includes a portal module 101, an index module 102 and a resource management nodule 103.

The portal module 101 is configured to receive a query request carrying address information transmitted from an ordinary node, query a correspondence relationship between address information and hosting domains according to the address information to determine a hosting domain of the ordinary node and return information on a domain server of the hosting domain.

In particular, the portal module 101 may be configured to store the correspondence relationship between address information and hosting domains of ordinary nodes.

The index module 102 is configured to receive streaming media data request information transmitted from a domain server and return information on domain servers in a core network currently possessing streaming media data requested by the ordinary node.

In particular, the index module 102 may be configured to store information on streaming media data possessed currently by the domain servers.

The index module 102 is further configured to receive a streaming media information update request transmitted from a domain server and update the locally stored information on the streaming media data possessed currently by the domain servers in response to the received streaming media information update request.

The index module 102 is further configured to count requests for streaming media data over respective streaming media channels in the core network and broadcast information on domain servers possessing streaming media data with a count of requests exceeding a preset value over the core network.

The resource management module 103 is configured to receive a streaming media data retrieval request transmitted from a domain server and return the locally stored requested streaming media data.

In particular, the resource management module 103 may further be configured to store streaming media source data.

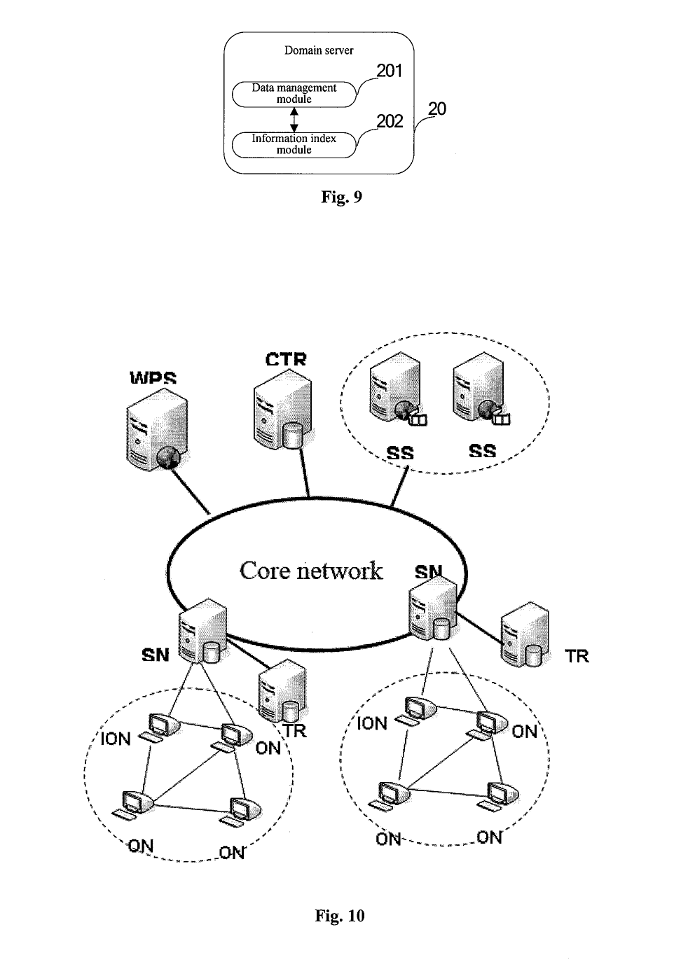

As illustrated in FIG. 9, the domain server 20 includes a data management module 201 and an information index module 202.

The data management module 201 is configured to receive a streaming media data retrieval request transmitted from an ordinary node in the same domain, and return locally stored requested streaming media data, or retrieve the requested streaming media data from other domain servers or a global server in a core network and return the retrieved streaming media data to the ordinary node transmitting the request.

In particular, the data management module 201 may be configured to locally store the retrieved streaming media data.

The data management module 201 is further configured to receive information on domain servers possessing streaming media data with a count of requests exceeding a preset value as broadcast from the global server, and establish connections to a part or all of the domain servers possessing the streaming media data and retrieve the streaming media data when the streaming media data is not stored locally.

The information index module 202 is configured to receive the streaming media data retrieval request transmitted from the ordinary node in the same domain and return information on other ordinary nodes in the same domain currently possessing the requested streaming media data.

In particular, the information index module 202 may be configured to store information on streaming media data possessed currently by the ordinary nodes in the same domain.

The information index module 202 is further configured to select one of the ordinary nodes in the same domain as an intermediate ordinary node upon reception of a streaming media data retrieval request transmitted from a mobile terminal, or select another ordinary node in the same domain as an intermediate ordinary node upon reception of a streaming media data retrieval request transmitted from an ordinary node in the same domain and transmit address information of the intermediate ordinary node to the mobile terminal or ordinary node transmitting the request.

The information index module 202 is further configured to receive a streaming media information update request transmitted from an ordinary node in the same domain and update the locally stored information on the streaming media data possessed currently by the ordinary nodes in the same domain.

In particular, the modules in the global server may be arranged as separate servers, for example, the functions performed by the global server may be performed by a Web Portal Server (WPS), a Core Tracker (CTR) and a Seeder Server (SS).

In particular, the Web Portal Server (WPS) performs the function of the portal module 101 to present a list of channel resources to a user and to return information on a hosting domain of an ordinary node upon reception of a query request.

The Core Tracker (CTR) performs the function of the index module 102 to store the information on the streaming media data possessed by all of the domain servers (or referred to as Super Nodes (SNs)) and to serve a query from the domain server about the information on the streaming media data.

The Seeder Server (SS) performs the function of the resource management module 103 to store source data of streaming media in the core network and to function as a seeder server of resources in the domain servers throughout the system.

The modules in the domain server may be arranged as separate node devices, for example, the functions performed by the domain server may be performed by a Super Node (SN) and a Tracker (TR).

In particular, the Super Node (SN) performs the function of the data management module 201 to function as a source node of streaming media resource in the same domain and to function for an access of and as a proxy for an ordinary node to enable the ordinary node to join into the same domain.

The Super Node (SN) periodically reports information on its own streaming media data to the Core Tracker (CTR) and the TR.

The Super Node (SN) can retrieve, from the Seeder Server (SS)/other domain servers, the streaming media data requested by the ordinary node.

The Super Node (SN) also can retrieve, from the Seeder Server (SS)/other domain servers, and buffer locally hot contents for downloading by the ordinary nodes in the same domain.

The TR performs the function of the information index module 202 to store distribution information on the streaming media data possessed by the Super Node (SN) and all of the ordinary nodes in the same domain, i.e., the information on the nodes of the streaming media data.

The TR may periodically count resources possessed in the Super Node (SN) and the ordinary nodes in the same domain to obtain a record of resource information for reference by the Super Node (SN) and the ordinary nodes.

The TR may also select an appropriate ordinary node as an Intermediate Ordinary Node (ION) for access of the mobile terminal.

Super Nodes (SNs) and TRs may be deployed in the following ways.

(1) The Super Nodes (SNs) in respective domains are deployed through P2P into a Distributed Hash Table (DHT) loop-like architecture (simply a DHT loop), and the TRs in the respective domains are deployed without direct communication therebetween. Messages are exchanged between the domains through the Super Nodes (SNs).

(2) The Super Nodes (SNs) in respective domains are deployed through P2P into a DHT loop, and also the TRs in the respective domains are deployed through P2P into a DHT loop. Messages are exchanged between the domains through the Super Nodes (SNs)/the TRs.

(3) The Super Nodes (SNs) in respective domains are deployed without direct communication therebetween, and the TRs in the respective domains are deployed through P2P into a DHT loop. Messages are exchanged between the domains through the TRs.

In particular, the Super Nodes (SNs) and the TRs in the respective domains may exchange information with the CTR, which manages the Super Nodes (SNs) and the TRs in the respective domains, and the Super Nodes (SNs) in the respective domains may exchange information with the seeder server and retrieve the resources including the streaming media data from the seeder server.

FIG. 10 illustrates a structure of an example below, in which a Web Portal Server (WPS), Seeder Servers (SSs) and a CTR are arranged separately to perform the functions of a global server, and also a Super Node (SN) and a TR are arranged separately to perform the functions of a domain server, and the Super Nodes (SNs) in respective domains are deployed through P2P.

In the system for delivering streaming media illustrated in FIG. 10, a Web Portal Server (WPS), Seeder Servers (SSs) and a CTR are deployed by an operator to reduce traffic over an upper layer of a core network and to guarantee the quality of service for delivery of streaming media; the Super Nodes (SNs) are deployed through P2P while the TRs in respective domains are deployed without direct communication therebetween, and messages are exchanged between the domains through the Super Nodes (SNs); and Ordinary Nodes (including an Intermediate Ordinary Node (ION)) and the Super Node (SN) in each of the domains are deployed through P2P.

An implementation of mass delivery of streaming media via the system for delivering streaming media according to an embodiment of the invention is described in details below taking the system for delivering streaming media illustrated in FIG. 10 as an example.

### A First Embodiment

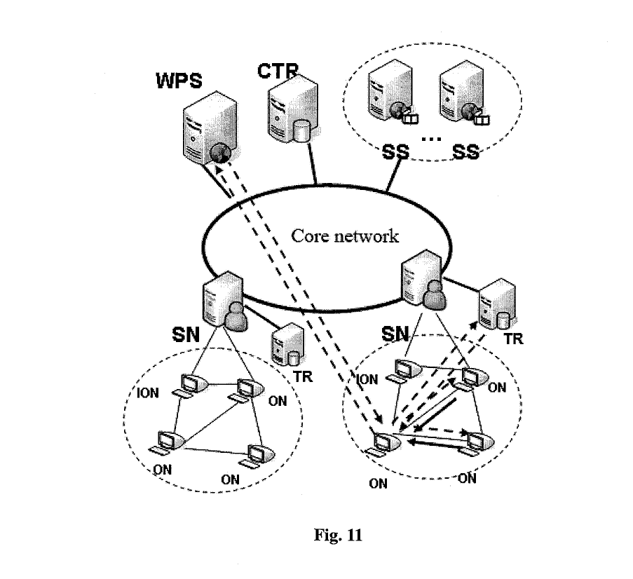

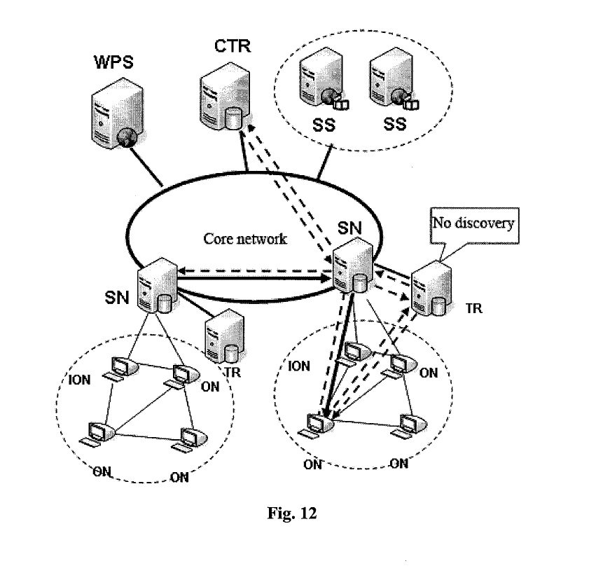

FIGS. 11 and 12 illustrate processes of retrieval of streaming media data from the hosting domain and from outside of the hosting domain respectively, which include the following operations S301-S311.

In the operation S301, an Ordinary Node (ON) transmits a query request carrying its own address information to a Web Portal Server (WPS) upon acquisition of a streaming media channel selected by a user.

In the operation S302, the WPS determines, from the address information included in the received query request, a hosting domain of the Ordinary Node (ON) transmitting the query request, retrieves information on a Super Node (SN) and a TR of the hosting domain, which includes at least IP addresses of the Super Node (SN) and the TR, and transmits the determined information on the Super Node (SN) and the TR to the Ordinary Node (ON).

In the operation S303, the Ordinary Node (ON), upon reception of the information on the Super Node (SN) and the TR of the hosting domain, transmits streaming media data request information to the TR in the hosting domain according to the address information of the TR and inquires about whether there is information on nodes (including ordinary nodes and the Super Node) possessing the requested streaming media data.

In the operation S304, the TR inquires about whether the streaming media data requested by the Ordinary Node (ON) is present in the hosting domain. That is, the TR inquires about whether information on the streaming media data requested by the Ordinary Node (ON) is stored locally.

If so, the process goes to the operation S305; otherwise, the process goes to the operation S306.

In the operation S305, the TR returns information on other nodes possessing the requested streaming media data to the ordinary node; the Ordinary Node (ON) establishes connections to a part or all of the other nodes according to the information on the other nodes returned from the TR; and the Ordinary Node (ON) retrieves the requested streaming media data from those of the nodes to which the connections have been established successfully and transmits a streaming media data update request to the TR in the hosting domain to update information on the streaming media data in the TR.

In the operation S306, the TR forwards the streaming media data request information to the Super Node (SN) in the hosting domain.

In the operation S307, the Super Node (SN) transmits a query request to a CTR at the layer of a core network and inquires about whether the streaming media data requested by the ordinary node is present in other Super Nodes (SNs) and Seeder Servers (SSs).

In the operation S308, the CTR returns information on super nodes/seeder servers possessing the requested streaming media data to the Super Node (SN) in the domain where the ordinary node resides (i.e., the Super Node (SN) transmitting the query request).

In the operation S309, the Super Node (SN) transmitting the query request establishes connections to a part or all of the Super Nodes (SNs)/the Seeder Servers (SSs) possessing the requested streaming media data upon reception of the information on the super nodes/the seeder servers; and retrieves the requested streaming media data from those of the Super Nodes (SNs)/the Seeder Servers (SSs) to which the connections have been established successfully. Furthermore, the Super Node (SN) transmits a streaming media data update request to the TR in the hosting domain and the CTR to update the information on the streaming media data in the TR in the hosting domain and the CTR.

In the operation S310, the TR in the hosting domain returns the information, on the nodes possessing the requested streaming media data, included in the updated information on the streaming media data to the Ordinary Node (ON) transmitting the request information.

In the operation S311, the Ordinary Node (ON) establishes a connection with the Super Node (SN) in the hosting domain according to the information on the nodes returned from the TR; and retrieves the requested streaming media data from the Super Node (SN) in the hosting domain. Furthermore, the Ordinary Node (ON) transmits a streaming media data update request to the TR in the hosting domain to update the current information on the streaming media data in the TR.

### A Second Embodiment

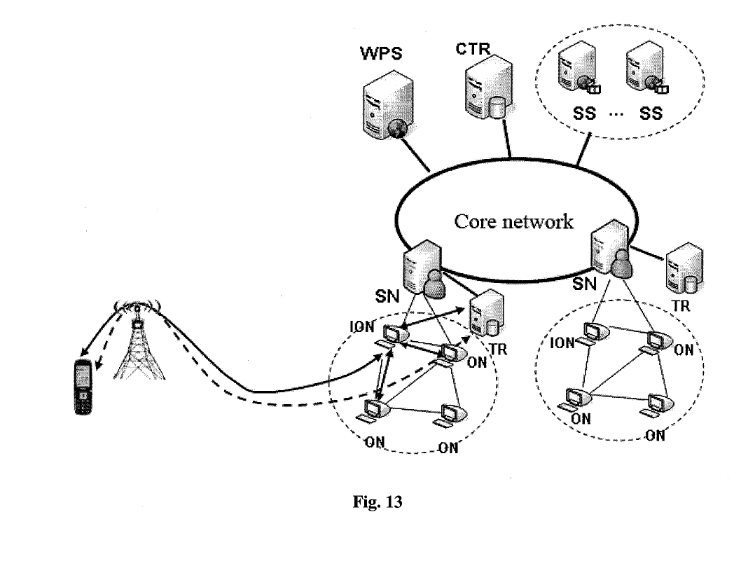

FIG. 13 illustrates a process of retrieving streaming media data by a mobile terminal through an Intermediate Ordinary Node (ION), which includes the following operations S401-S413.

In the operation S401, a mobile terminal, upon determining its hosting domain, transmits streaming media data request information to a TR in the hosting domain to inquire information on nodes (including ordinary nodes and a super node) possessing the requested streaming media data.

In the operation S402, the TR determines that the mobile terminal is incapable of a direct access, selects one of the ordinary nodes as an Intermediate Ordinary Node (ION) of the mobile terminal and returns information (including an IP address) on the selected Intermediate Ordinary Node (ION) to the mobile terminal.

In the operation S403, the TR inquires about whether the streaming media data requested by the mobile terminal is present in the hosting domain. That is, the TR inquires about whether information on the streaming media data requested by the mobile terminal is stored locally.

If so, the process goes to the operation S404; otherwise, the process goes to the operation S407.

In the operation S404, the TR transmits information on other nodes possessing the requested streaming media data to the selected Intermediate Ordinary Node (ION).

In the operation S405, the Intermediate Ordinary Node (ION) establishes connections to a part or all of the other nodes according to the information on the other nodes returned from the TR; and retrieves the requested streaming media data from those of the nodes to which the connections have been established successfully. Furthermore, the Intermediate Ordinary Node (ION) transmits a streaming media data update request to the TR in the hosting domain to update information on the streaming media data in the TR.

In the operation S406, the mobile terminal establishes a connection to the Intermediate Ordinary Node (ION) and downloads the requested streaming media data from the Intermediate Ordinary Node (ION) without being involved in delivery of the streaming media data in the system.

In the operation S407, the TR forwards the streaming data request information to the Super Node (SN) in the hosting domain.

In the operation S408, the Super Node (SN) transmits a query request to a CTR at the layer of a core network to inquire about whether the streaming media data requested by the mobile terminal is present in other Super Nodes (SNs) and Seeder Servers (SSs).

In the operation S409, the CTR returns information on super nodes/seeder servers possessing the requested streaming media data to the Super Node (SN) in the domain where the mobile terminal resides (i.e., the Super Node (SN) transmitting the query request).

In the operation S410, the Super Node (SN) transmitting the query request establishes connections to a part or all of the Super Nodes (SNs) and the Seeder Servers (SSs) possessing the requested streaming media data upon reception of the information on the super nodes/the seeder servers; and retrieves the requested streaming media data from those of the Super Nodes (SNs)/the Seeder Servers (SSs) to which the connections have been established successfully.

Furthermore, the Super Node (SN) transmits a streaming media data update request to the TR in the hosting domain and the CTR to update the information on the streaming media data in the TR in the hosting domain and the CTR.

In the operation S411, the TR selects one of the nodes as an Intermediate Ordinary Node (ION) of the mobile terminal and returns information (including an IP address) on the Intermediate Ordinary Node (ION) to the mobile terminal; and returns the information, on the nodes possessing the requested streaming media data, included in the updated information on the streaming media data to the Intermediate Ordinary Node (ION).

In the operation S412, the Intermediate Ordinary Node (ION) establishes a connection to the Super Node (SN) in the hosting domain according to the information on the nodes returned from the TR; and retrieves the requested streaming media data from the Super Node (SN) in the hosting domain; and also transmits a streaming media data update request to the TR in the hosting domain to update the current information on the streaming media data in the TR.

In the operation S413, the mobile terminal establishes a connection to the Intermediate Ordinary Node (ION); and downloads the requested streaming media data from the Intermediate Ordinary Node (ION) without being involved in delivery of the streaming media data in the system.

### A Third Embodiment

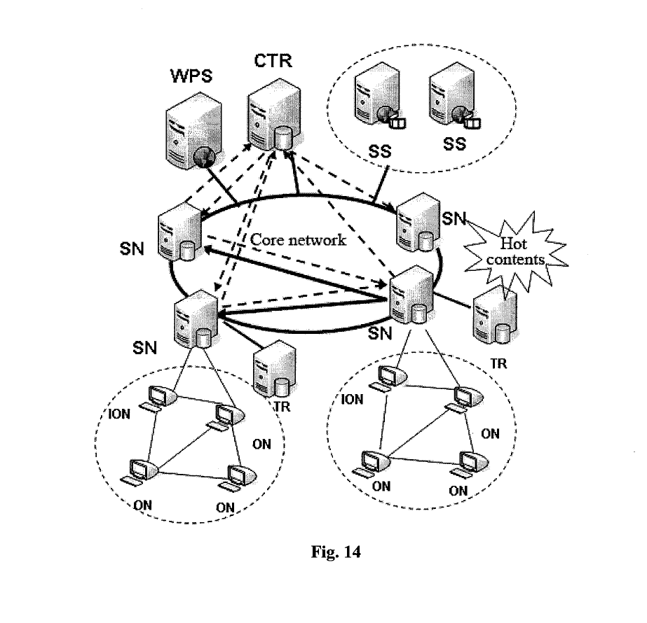

FIG. 14 illustrates a process of sharing hot contents between Super Nodes (SNs), which includes the following operations S501-S504.

In the operation S501, a CTR counts requests for streaming media data over each streaming media channel in a domain server and then determines the streaming media data over the streaming media channel with a count of requests exceeding a preset value as hot contents.

In particular, streaming media data over a certain streaming media channel may alternatively be determined as hot contents according to some other experiential data.

In the operation S502, the CTR broadcasts information on the Super Nodes (SNs) possessing the hot contents to all of the Super Nodes (SNs) in the system.

In the operation S503, a Super Node (SN) not possessing the hot contents establishes connections to a part or all of Super Nodes (SN) possessing the hot contents according to the received information on the super nodes upon reception of the broadcast message and retrieves the streaming media data of the hot contents from those of the Super Nodes (SN) to which the connections have been established successfully, and transmits a streaming media data update request to update information on the streaming media data in an TR in the hosting domain and the CTR.

In the operation S504, the CTR updates and broadcasts the information on the nodes possessing the hot contents until all of the Super Nodes (SNs) possess the hot contents.

The two-level P2P architecture is adopted in the method and system for mass delivery of streaming media according to the embodiments of the invention and used in combination with the hybrid architecture of CDN and P2P to perform mass delivery of streaming media while benefiting from the advantages of reliability and extensibility of both of them to thereby be both capable of serving QoS-guaranteed mass delivery of streaming media and advantageous in terms of a lower cost of deployment.

The hybrid architecture of P2P and hierarchy makes full use of resources (CPU, memory, network bandwidth resources, etc.) of a global server, domain servers and ordinary nodes to constitute a highly extensible system for delivering streaming media, to serve a user with mass P2P live videos and videos on demand; and the ordinary node can function both a downloading client and a server for the purpose of decentralized delivery of streaming media data, thereby alleviating an I/O load on the server, reducing the number of servers and lessening a required network bandwidth.

The ordinary nodes are deployed in respective domains for the purpose of controlling traffic, and the respective domains are controlled through the domain servers (or referred to as Super Node (SN) and TR) to localize traffic, thereby reducing load traffic over the core backbone network.

Also a global server (or a Web Portal Server (WPS), a Seeder Server (SS) and a CTR) and a DHT loop may be deployed to function for data backup and disaster tolerance. When a node of the DHT loop fails or malfunctions, information thereof is still stored at the global server (or the Web Portal Server (WPS), the Seeder Server (SS) and the CTR) to thereby improve reliability of the system.

A user of a Personal Computer (PC) accesses directly the system using the Personal Computer (PC) as an ordinary node and downloads requested streaming media data and also participates in delivery of streaming media contents over the network; and a terminal with a high computing capability may act as an intermediate ordinary node so that a mobile terminal and an ordinary node with a weak computing capability can access the system and retrieve requested streaming media data through the intermediate ordinary node but will not participate in delivery of streaming media contents over the network, thereby accommodating a download demand of performance varying terminals and offering good universal applicability.

The method and system for mass delivery of streaming media according to the embodiments of the invention can accommodate a demand of a large number of concurrent users for downloading streaming media data and offer strong extensibility and high reliability of the system and also improve the QoS of the system at a lowered cost of deploying the system.

The foregoing description is merely illustrative of the preferred embodiments of the invention, but the scope of the invention will not be limited thereto, and any variations, substitutions or applications to other similar devices which may occur to those skilled in the art without departing from the spirit of the invention shall come into the scope of the invention. Accordingly, the scope of the invention shall comply with that defined in the appended claims.

1-6. (canceled)

7. A method for delivering streaming media, comprising:
transmitting, by an ordinary node, a query request carrying its own address information to a global server;
querying, by the global server, a correspondence relationship between address information and hosting domains according to the address information in the query request, determining a hosting domain of the ordinary node and returning information on a domain server of the hosting domain, wherein the global server and domain servers constitute a Peer-to-Peer, P2P, core network, and the domain server and ordinary nodes hosted in the domain constitute a P2P access network;
transmitting, by the ordinary node, a streaming media data retrieval request to the domain server of the hosting domain;
inquiring, by the domain server of the hosting domain, about whether the requested streaming media data is present in the hosting domain; and if so, returning the locally stored streaming media data and/or information on other ordinary nodes in the hosting domain possessing the requested streaming media data; otherwise, retrieving the requested streaming media data from other domain servers and/or the global server in the core network through P2P and transmitting the retrieved streaming media data to the ordinary node transmitting the retrieval request; and
receiving, by the ordinary node, the returned streaming media data and/or retrieving the requested streaming media data from the other ordinary nodes through P2P according to the returned information on the other ordinary nodes.

8. The method of claim 7, further comprising:
selecting, by the domain server of the hosting domain, one of the ordinary nodes in the hosting domain as an intermediate ordinary node and returning address information of the intermediate ordinary node to the ordinary node transmitting the stream media data retrieval request;
transmitting, by the domain server of the hosting domain, the locally stored streaming media data and/or the information on the other ordinary nodes in the hosting domain possessing the streaming media data to the intermediate ordinary node upon determining presence of the streaming media data in the hosting domain or retrieving the requested streaming media data from other domain servers or the global server in the core network through P2P and transmitting the retrieved streaming media data to the intermediate ordinary node upon determining absence of the streaming media data in the hosting domain;
receiving, by the intermediate ordinary node, the returned streaming media data and/or retrieving the requested streaming media data from the other ordinary nodes through P2P according to the returned information on the other ordinary nodes; and
establishing, by the ordinary node, a connection to the intermediate ordinary node according to the address information of the intermediate ordinary node and retrieving the requested streaming media data.

9. The method of claim 7, wherein retrieving the requested streaming media data from other domain servers or the global server in the core network through P2P comprises:
forwarding, by the domain server of the hosting domain, the retrieval request to the global server;
returning, by the global server, the requested streaming media data and/or information on other domain servers in the core network currently possessing the requested streaming media data; and
storing, by the domain server of the hosting domain, the returned streaming media data or retrieving the requested streaming media data from the other domain servers.

10. The method of claim 7, further comprising:
transmitting, by the ordinary node, a streaming media information update request to the domain server of the hosting domain upon retrieval of streaming media data or deletion of possessed streaming media data, and updating, by the domain server of the hosting domain, locally stored information on the streaming media data possessed currently by the ordinary nodes in the hosting domain in response to the received streaming media information update request.

11. The method of claim 10, further comprising:
transmitting, by the domain server, a streaming media information update request to the global server upon retrieval of streaming media data or deletion of possessed streaming media data, and updating, by the global server, locally stored information on the streaming media data possessed currently by the domain servers in the core network in response to the received streaming media information update request.

12. The method of claim 10, further comprising:
counting, by the global server, requests for streaming media data over streaming media channels in the domain servers and broadcasting information on those of the domain servers possessing streaming media data with a count of requests exceeding a preset value over the core network; and
establishing, by the domain server, connections to a part or all of the broadcast domain servers and retrieving and storing the streaming media data when determining that the streaming media data is not stored locally upon reception of the broadcast.

13. A global server, comprising a portal module, an index module and a resource management module, wherein:
the portal module is configured to receive a query request carrying address information transmitted from an ordinary node, query a correspondence relationship between address information and hosting domains according to the address information in the query request to determine a hosting domain of the ordinary node, and return information on a domain server of the hosting domain;
the index module is configured to receive streaming media data request information transmitted from the domain server and return information on domain servers in a core network possessing the streaming media data; and
the resource management module is configured to receive a streaming media data retrieval request transmitted from the domain server and return the locally stored requested streaming media data.

14. The global server of claim 13, wherein the index module is further configured to receive a streaming media information update request transmitted from the domain server and update locally stored information on streaming media data possessed currently by the domain server in response to the received streaming media information update request.

15. The global server of claim 13, wherein the index module is further configured to count requests for streaming media data over streaming media channels in the domain servers and broadcast information on domain servers possessing streaming media data with a count of requests exceeding a preset value over the core network.

16. A domain server, comprising a data management module and an information index module, wherein:
the data management module is configured to receive a streaming media data retrieval request transmitted from an ordinary node in a hosting domain, and return locally stored requested streaming media data or retrieve the streaming media data from other domain servers or a global server in a core network and return the retrieved streaming media data to the ordinary node transmitting the retrieval request; and
the information index module is configured to receive the streaming media data retrieval request transmitted from the ordinary node in the hosting domain and return information on other ordinary nodes in the same domain currently possessing the streaming media data.

17. The domain server of claim 16, wherein the information index module is further configured to select one of the ordinary nodes in the hosting domain as an intermediate ordinary node upon reception of a streaming media data retrieval request transmitted from a mobile terminal or select another ordinary node in the hosting domain as an intermediate ordinary node upon reception of the streaming media data retrieval request transmitted from the ordinary node in the hosting domain, and transmit address information of the intermediate ordinary node to the mobile terminal or the ordinary node.

18. The domain server of claim 16, wherein the information index module is further configured to receive a streaming media information update request transmitted from the ordinary node in the hosting domain and update locally stored information on streaming media data possessed currently by the ordinary node in the hosting domain.

19. The domain server of claim 18, wherein the data management module is further configured to receive information on domain servers possessing streaming media data with a count of requests exceeding a preset value as broadcast from the global server; and establish connections to a part or all of the broadcast domain servers possessing the streaming media data and retrieve the streaming media data when the streaming media data is not stored locally.

20. The method of claim 8, further comprising:
transmitting, by the intermediate ordinary node, a streaming media information update request to the domain server of the hosting domain upon retrieval of streaming media data or deletion of possessed streaming media data, and updating, by the domain server of the hosting domain, locally stored information on the streaming media data possessed currently by the ordinary nodes in the hosting domain in response to the received streaming media information update request.

21. The method of claim 9, further comprising:
transmitting, by the ordinary node, a streaming media information update request to the domain server of the hosting domain upon retrieval of streaming media data or deletion of possessed streaming media data, and updating, by the domain server of the hosting domain, locally stored information on the streaming media data possessed currently by the ordinary nodes in the hosting domain in response to the received streaming media information update request.

22. The global server of claim 14, wherein the index module is further configured to count requests for streaming media data over streaming media channels in the domain servers and broadcast information on domain servers possessing streaming media data with a count of requests exceeding a preset value over the core network.

23. The domain server of claim 17, wherein the information index module is further configured to receive a streaming media information update request transmitted from the ordinary node in the hosting domain and update locally stored information on streaming media data possessed currently by the ordinary node in the hosting domain.
